(19) United States
(12) Patent Application Publication
(10) Pub. No.: US 2012/0015662 A1
(43) Pub. Date: Jan. 19, 2012

(54) RELAY COLLABORATIVE COMMUNICATION SYSTEM AND COMMUNICATION METHOD

(76) Inventors: Yingyu Zhang, Shanghai (CN); Renmao Liu, Shanghai (CN); Lei Huang, Shanghai (CN); Ming Ding, Shanghai (CN); Guolin Sun, Shanghai (CN); Chen Chen, Shanghai (CN)

(21) Appl. No.: 13/146,956

(22) PCT Filed: Feb. 2, 2010
(86) PCT No.: PCT/JP2010/000598

§ 371 Date: Jul. 29, 2011

(30) Foreign Application Priority Data
Feb. 2, 2009 (CN) 200910009652.0

(51) Int. Cl. H04W 40/00

(52) U.S. Cl. 455/445

(57) ABSTRACT

The present invention provides a relay collaborative cellular mobile communication system and a communication method of the system. In the method, all relay stations or a base station and relay stations in a cell (i) measure all uplink signals such as uplink reference signals and random-access signals from user devices for obtaining reception qualities of uplink signals of the user devices at the sites and (ii) feed back measurement results to the base station. The base station determines a transmission route of a user device based on the measurement results. A site in a transmission route processes schedule control information and then transmits the information to the user device for performing, based on lumped scheduling of the base station, a downlink reception, an uplink transmission, an uplink retransmission, or a downlink retransmission. In an uplink HARQ mechanism, the site in the transmission route receives an uplink signal from the user device, feeds back an ACK to the user device, and transmits a processed uplink signal to the base station, or feeds back an NACK or an ACK to the base station. The base station judges, based on results of decoding and detecting transmitted data or feedback results from the sites in the transmission route, whether or not the current uplink transmission is successful or whether to adjust the uplink retransmission.

### TECHNICAL FIELD

The present invention relates to a cellular mobile communication system. Specifically, the present invention relates to a scheduling method of a hybrid automatic repeat request (HARQ) which is applied to a mobile communication system utilizing a relaying technique.

### BACKGROUND ART

As information technology develops, demands for decreasing delay in access by mobile terminals are increasing. Moreover, it is necessary to further improve the transmission rate in the future mobile communication system. On the other hand, such improvement would cause a problem of reducing a coverage area of a conventional cellular cell. A basic function of a wireless relaying technique is to reprocess a signal from a base station and transmit the signal thus reprocessed with the use of a relay node so as to expand the coverage of a cell for reducing a dead spot of communication. Such a wireless relaying technique makes it possible to disperse services in a hotspot area by taking into consideration balance of loads. Moreover, the relaying technique makes it possible to extend a battery life of a terminal by decreasing transmission power of the terminal. The idea of the relaying technique may be applied to standardization in future systems such as mobile communications (3GPP, 3GPP2), a wireless LAN (WLAN), and broadband wireless network (IEEE802.16j). The following discusses a problem of relay collaborative communication.

The introduction of the relay station changes a topological configuration of the conventional cellular communication. In order to carry out communication between a base station and a user device (also called “mobile station”), it is necessary to allocate corresponding wireless resources so that signals can be transmitted (i) between a relay station and the base station and (ii) between the user device and the relay station. A method for allocating different time resources to two links, that is, a method, in which a relay station carries out communications with a base station and a user device with the use of a time division system, is an easy and effective method. This method is applied to both an FDD (frequency division duplex) system and a TDD (time division duplex) system. The relay station cannot concurrently carry out reception and transmission of signals. Specifically, in the FDD system, the relay station does not carryout a downlink transmission to the user device when the relay station receives a downlink-transmitted signal from the base station via a backhaul link. Similarly, when the base station receives an uplink transmitted signal from the relay station, the relay station does not carry out uplink reception from the user device.

### SUMMARY OF INVENTION

### Technical Problem

As described above, the use of a relay station makes it possible to expand the coverage area of a cell. However, this causes a problem of decreasing transmission efficiency. In an actual system, such decrease in transmission efficiency means an extension of an HARQ cycle required for carrying out a data transmission between terminals (i.e., base station and user device). Similarly, in a case where a user device normally carries out an HARQ process, a situation occurs where a relay station has to concurrently carry out a reception and a transmission of signals, due to the presence of a backhaul link and an HARQ periodicity.

In view of the problem, the present invention provides a solution to scheduling of HARQ in a cellular system in which a relay station collaboratively carries out a communication.

### Solution to Problem

According to the present invention, a set regarding route sites of physical downlink control channels (PDCCH) is defined as a set of signaling transmission routes, and a set regarding route sites of data channels is defined as a set of data transmission routes. With regard to data channels, uplink data and downlink data have identical routing systems. That is, a set of data transmission routes is used both in an uplink and a downlink. Moreover, physical uplink control channels (PUCCH) employ a routing system which is identical to that of the data channels. Therefore, all sets of signaling transmission routes in the present invention are sets of sites on physical downlink control channels (PDCCH).

Moreover, a user device, which belongs to a set of routs having no relay station (i.e., a user device which communicates with a base station), is defined as a base station user device, and a user device, which belongs to a set of routs having no base station (i.e., a user device which communicates with a relay station), is defined as a relayed user device. Note that the base station can also cooperate with a communication of the relayed user device.

Here, unless otherwise particularly described, a site of the present invention is a base station or a relay station. Moreover, a user device of the present invention is a relayed user device or a base station user device.

A communication method of the present invention is a communication method of a relay collaborative cellular communication system including a base station and at least one relay station, the communication method including the steps of: (a) causing the at least one relay station or the at least one relay station and the base station to measure a reception quality of an uplink signal transmitted from each user device; (b) causing the at least one relay station to feed back a measured reception quality to the base station; and (c) causing the base station to determine a transmission route between the each user device and the base station based on the reception quality.

A communication method of the present invention is a communication method of a relay collaborative cellular communication system including a base station and at least one relay station, the communication method including the steps of: (a) causing the base station to determine a route site for a user device based on a reception quality measured by (i) the base station and the at least one relay station or (ii) the at least one relay station; (b) causing the user device to transmit a signal with use of an uplink resource which is allocated to the user device; (c) causing the user device to carry out, based on lumped scheduling of the base station, a downlink reception, an uplink transmission, an uplink retransmission, or a downlink re-reception, and causing the route site to process schedule control information and to transmit the schedule control information to the user device; and (d) in an uplink HARQ mechanism, causing the at least one relay station or the at least one relay station and the base station to feed back a confirmation of accurate reception to the user device, regardless of whether or not the at least one relay station or the at least one relay station and the base station successfully receive(s) an uplink signal transmitted from the user device.

A relay collaborative cellular communication system of the present invention is a relay collaborative cellular communication system including a base station and at least one of relay station, the at least one relay station including: a first receiving device which receives a first signal from a user device, a first measuring device which measures a first reception quality of the first signal, and a transmitting device which feeds back the first reception quality from the at least one relay station to the base station; and the base station including: a second receiving device which receives a second signal from the user device, a second measuring device which measures a second reception quality of the second signal, and a route determining device which determines a transmission route between the user device and the base station based on the first reception quality and the second reception quality.

According to the uplink and downlink HARQ mechanisms, how to determine (i) a set of signaling transmission routes of the user device and (ii) a set of data transmission routes of the user device is not limited to the method proposed in the present invention.

### Advantageous Effects of Invention

The configuration of the present invention makes it possible to improve transmission efficiency in a relay collaborative cellular communication system.

### BRIEF DESCRIPTION OF DRAWINGS

FIG. 1A is a schematic view illustrating (i) a configuration of a communication system and (ii) a process in which relay stations obtain reception qualities of uplink signals transmitted from user devices, in accordance with an embodiment of the present invention.

FIG. 1B is a block diagram illustrating a configuration of a relay station in a communication system in accordance with an embodiment of the present invention.

FIG. 1C is a block diagram illustrating a configuration of a base station in a communication system in accordance with an embodiment of the present invention.

FIG. 2 is a schematic view illustrating a process in which a base station selects transmission routes of user devices, based on reception qualities of uplink signals fed back by relay stations.

FIG. 3 is a view illustrating a first example of allocating wireless resources to uplinks and downlinks of relay stations.

FIG. 4 is a view illustrating a second example of allocating wireless resources to uplinks and downlinks of relay stations.

FIG. 5 is a view illustrating a third example of allocating wireless resources to uplinks and downlinks of relay stations.

FIG. 6 is a view illustrating a configuration of an FDD LTE frame.

FIG. 7 is a view illustrating an arrangement example in a backhaul link with the use of blank sub-frames.

FIG. 8 is a view illustrating an arrangement example in a backhaul link with the use of MBSFN sub-frames.

FIG. 9 is a view illustrating a first method of a first transmission and a self-adapting retransmission in an uplink HARQ.

FIG. 10 is a view illustrating a second method of a first transmission and a self-adapting retransmission in an uplink HARQ.

FIG. 11 is a view illustrating an example of a time sequence of a first transmission and a self-adapting retransmission in an uplink HARQ with the use of blank sub-frames.

FIG. 12 is a view illustrating an example of a time sequence of a first transmission and a self-adapting retransmission in an uplink HARQ with the use of MBSFN sub-frames.

FIG. 13 is a view illustrating an example of a time sequence of an ACK feedback in an uplink HARQ with the use of blank sub-frames.

FIG. 14 is a view illustrating an example of a time sequence of an ACK feedback in an uplink HARQ with the use of MBSFN sub-frames.

FIG. 15 is a view illustrating a feedback of ACK/NACK and a retransmission in a downlink HARQ.

FIG. 16 is a schematic view illustrating an example of a time sequence of an NACK feedback and a retransmission in a downlink HARQ with the use of blank sub-frames.

FIG. 17 is a schematic view illustrating an example of a time sequence of an NACK feedback and a retransmission in a downlink HARQ with the use of MBSFN sub-frames.

FIG. 18 is a schematic view illustrating an example of a time sequence of an ACK feedback and a retransmission in a downlink HARQ with the use of blank sub-frames.

FIG. 19 is a schematic view illustrating an example of a time sequence of an ACK feedback and a retransmission in a downlink HARQ with the use of MBSFN sub-frames.

### DESCRIPTION OF EMBODIMENTS

The following describes a preferred embodiment of the present invention with reference to drawings. For easier understanding of the present invention, specific descriptions regarding unnecessary configurations and functions of the embodiment of the present invention are omitted.

In order to describe, more specifically and clearly, how to provide the present invention, the following describes a concrete embodiment which is applied to a cellular mobile communication system in which an LTE-Advanced technique is employed. A range of application of the present invention is of course not limited to the following embodiment. The present invention can be therefore applied to other mobile communication systems.

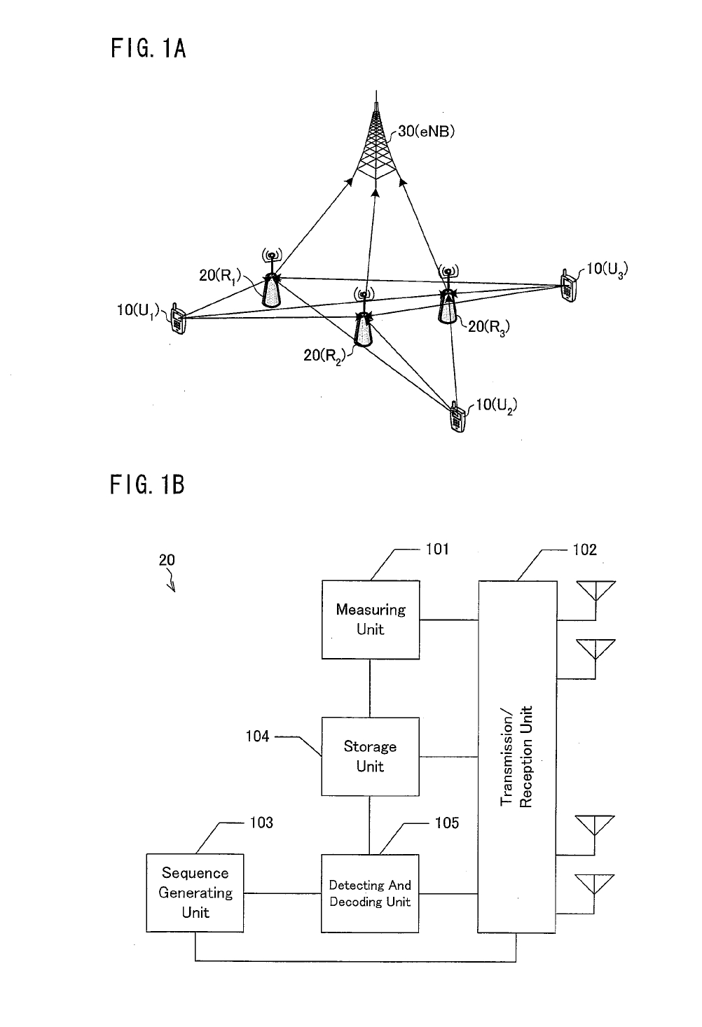

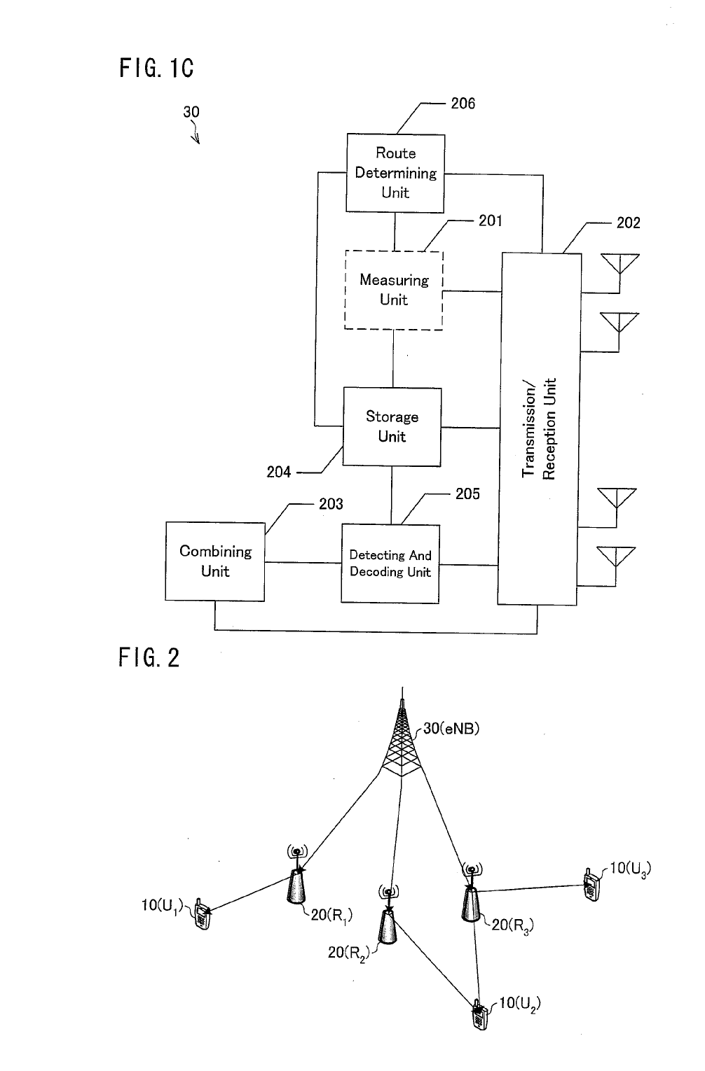

FIG. 1A is a schematic view illustrating a configuration of a relay collaborative communication system (relay collaborative cellular communication system) 1 in accordance with an embodiment of the present invention. The relay collaborative communication system 1 includes user devices 10 (U₁, U₂, and U₃), a base station (eNB) 30, and relay stations 20 (R₁, R₂, and R₃) which serve to relay the user devices 10 to the base station 30.

### [Selection of Transmission Route]

In a case where the relay stations 20 in a cell share a single frequency band, the user devices (hereinafter, referred to also as “relayed user devices”) 10, which are to be relayed, can receive control signals transmitted from the base station 30 and all the relay stations 20 in the cell. An intensity of a signal transmitted from each site (base station 30 or relay station 20) is determined by factors such as a distance between the respective relayed user devices 10 and the respective sites and shadowing. In this case, a set of transmission routes of signalings (hereinafter, referred to as “signaling transmission routes”), which signalings are control signals for the user devices 10, is (i) a set of all the relay stations 20 in the cell or (ii) a set of the base station 30 and all the relay stations 20 in the cell. Note that a set of transmission routes of user data (hereinafter, referred to as “data transmission route”) in data channels of each of the user devices 10 is a set of sites which are determined by the base station 30 based on reception qualities of uplink signals received by the respective sites. The set of data transmission routes data is, therefore, (i) a set of some of the relay stations 20 which get close to the relayed user device 10 or (ii) a set of the base station 30 and some of the relay stations 20 which get close to the user device (i.e., a relayed user device 10 or a user device (base station user device) 10 connected to the base station 30) 10.

In a case where the relay stations 20 in a cell use respective different frequency bands, each relayed user device 10 receives only signals transmitted from some of the relay stations 20 which are in the vicinity of the each relayed user device 10. In this case, a set of signaling transmission routes is a set of data transmission routes, i.e., a set of some of the relay stations 20 which are in the vicinity of the each relayed user device 10. Moreover, the set of data transmission routes and the set of signaling transmission routes include identical sites. Note that the set of data transmission routes is a set of sites which are determined by the base station 30 based on reception qualities of uplink signals received by the respective sites.

A routing of data channels of the user device 10, which requires communications via a plurality of site routes, (i) can be a macro-diversity of a site in the set of data transmission routes or (ii) can be multiplex transmissions which are carried out, in respective sites, with respect to wireless resources, at identical time and at identical frequencies.

Downlink control signals to the user devices 10 correspond to the set of signaling transmission routes, and data channels of the user devices 10 correspond to the set of data transmission routes. Here, examples of the set of the signaling transmission routes encompass the following sets:

[1] All relay stations 20 in a cell

[2] All relay stations 20 and a base station 30

All the sites in the set of signaling transmission routes of the user devices 10 share wireless resources, which are at identical time and at identical frequencies, so as to transmit downlink control signals to the user devices 10. The control signals transmitted from the relay stations 20 have identical pieces of control information, and reference signals (RS) overlap each other on user device 10 sides. The control signals in this system utilize a macro-diversity technique.

Moreover, examples of the set of data transmission routes of each of the user devices 10 encompass the following sets:

[1] Some of relay stations 20

[2] A base station 30 and some of relay stations 20

According to the present embodiment, each of the relay stations 20 in the relay collaborative communication system 1 includes units such as (i) a transmission/reception unit (first receiving device, transmitting device) 102 (e.g., a receiving module and a transmitting module) for transmitting/receiving a signal, (ii) a measuring unit (first measuring device) 101 for measuring reception qualities of signals received from user devices 10, (iii) a storage unit 104 for storing data and information, (iv) a detecting and decoding unit 105 which carries out a detection and a decoding process (decode checking) with respect to a signal received by the transmission/reception unit 102, and (v) a sequence generating unit 103 which reproduces a new symbolic sequence based on a result decoded (a result of decode checking) by the detecting and decoding unit 105 (see FIG. 1B).

According to the present embodiment, the base station in the relay collaborative communication system 1 includes units such as (i) a transmission/reception unit (second receiving device) 202 (e.g., a receiving module and a transmitting module) for transmitting/receiving a signal, (ii) a measuring unit (second measuring device) 201 for measuring reception qualities of signals received from user devices 10, (iii) a route determining unit (route determining device) 206 for determining a transmission route of a user device 10 based on a reception quality fed back by the relay station 20 and based on a reception quality measured by the measuring unit 201, (iv) a storage unit 204 for storing data and information, (v) a detecting and decoding unit 205 which carries out a detection and a decoding process with respect to a signal received by the transmission/reception unit 202, and (vi) a combining unit 203 for combining pieces of data received from respective different user devices 10 (e.g., for using a method such as maximum proportional combining) (see FIG. 1C).

The following description discusses, in detail with a concrete example, configurations of the base station 30 and the relay stations 20 in accordance with the present embodiment.

With regard to the base station 30, a system bandwidth of a downlink in a cell is represented by “W_{d}”, and a system bandwidth of an uplink is represented by “Wᵤ”. The relay stations 20 in the cell are represented by “relay stations 20(Rᵢ)”, where “i” is 1, 2, . . . , or r, which “r” indicates the number of the relay stations 20 in the cell. The user devices 10 in the cell are represented by “user devices 10(Uⱼ)”, where “j” is 1, 2, . . . , or u, which “u” indicates the number of the user devices 10 in the cell. According to the present embodiment, “r” is set to 3, and “u” is set to 3.

A set of data transmission routes is determined based on reception qualities of the relay stations 20(Rⱼ), in the cell, which receive an uplink signal from a user device 10(Uⱼ). According to the relay station 20 (Rᵢ (i=1, 2, . . . , or r)), the transmission/reception unit 102 receives an uplink signal from the user device 10(Uⱼ), and the measuring unit 101 carries out measurements of the uplink signals, with respect to each user device 10(Uⱼ), so as to obtain each parameter RSS_{i,j} which indicates a reception quality of a corresponding uplink signal. This causes each relay station 20(Rᵢ) to measure uplink signals received from each user device 10(Uⱼ), which the each relay station 20(Rᵢ) covers, so as to obtain one (1) parameter {RSS_{i,j}=1, 2, or Lu} for each of the user devices 10(Uⱼ). The each relay station 20(Rᵢ) feeds back measured results to the base station 30, via a backhaul link of the base station 30 and the each relay station 20(Rᵢ). The route determining unit 206 of the base station 30 determines a route of each user device 10(Uⱼ) in the cell by integrating (i) the measured results which are fed back by the relay stations Rᵢ and (ii) a measured result {RSS_{b,j}=1, 2, or Lu} of the base station 20(Rᵢ) itself. According to the base station 30, a table such as the following [Formula 1] or [Formula 2] is prepared based on the measured results of all the reception qualities, and is then stored in the storage unit 204.

$$\begin{matrix}RSS = ( \begin{matrix}{RSS}_{1 , 1} & {rSS}_{1 , 2} & … & {RSS}_{1 , j} & … & {RSS}_{1 , u} \\ {RSS}_{2 , 1} & {RSS}_{2 , 2} & … & {RSS}_{2 , j} & … & {RSS}_{2 , u} \\ … & … & … & … & … & … \\ {RSS}_{r , 1} & {RSS}_{r , 2} & … & {RSS}_{r , j} & … & {RSS}_{r , u}\end{matrix} ) \\ or & [ Formula 1 ] \\ {RSS}_{b} = ( \begin{matrix}{RSS}_{1 , 1} & {RSS}_{1 , 2} & … & {RSS}_{1 , j} & … & {RSS}_{1 , u} \\ {RsS}_{2 , 1} & {RSS}_{2 , 2} & … & {RSS}_{2 , j} & … & {RSS}_{2 , u} \\ … & … & … & … & … & … \\ {RSS}_{r , 1} & {RSS}_{r , 2} & … & {RSS}_{r , j} & … & {RSS}_{r , u} \\ {RSS}_{b , 1} & {RSS}_{b , 2} & … & {RSS}_{b , j} & … & {RSS}_{b , u}\end{matrix} ) & [ Formula 2 ]\end{matrix}$$

The following [Formula 3] or [Formula 4] indicates a reception quality of an uplink signal transmitted from a user device 10(Uⱼ), which reception quality is measured, with respect to the user device 10(Uⱼ), by each site.

$$\begin{matrix}{RSS}_{j} = ( \begin{matrix}{RSS}_{1 , j} \\ {RSS}_{2 , j} \\ … \\ {RSS}_{r , j}\end{matrix} ) \\ or & [ Formula 3 ] \\ {RSS}_{b}^{j} = ( \begin{matrix}{RSS}_{1 , j} \\ {RSS}_{2 , j} \\ … \\ {RSS}_{r , j} \\ {RSS}_{b , j}\end{matrix} ) & [ Formula 4 ]\end{matrix}$$

A criterion, based on which a route is determined by the route determining unit 206, is a received power, a carrier-to-interference ratio, or a signal-to-noise ratio, and a corresponding threshold value is set to RSS_{threshold}. The threshold value RSS_{threshold} is set in advance in the relay collaborative cellular communication system. Examples of the threshold value RSS_{threshold} encompass (i) a set value obtained by simulating and optimizing the relay collaborative cellular communication system, (ii) a statistical measured value obtained under a practical use environment of the relay collaborative cellular communication system, (iii) a calculated value obtained based on a system parameter, or (iv) a standardized value defined by specifications of the relay collaborative cellular communication system.

Criterion 1: in a case where a condition RSS_{k,j}≧RSS_{threshold} (k=1, 2, or Lr) or a condition RSS_{b,j}≧RSS_{threshold} is satisfied, a set DUⱼ (j=1, 2, or Lu) of sites, which satisfies such a condition and includes (i) sites k or (ii) sites k and a base station 30(b), serves as data transmission route sites of a user device 10(Uⱼ).

Criterion 2: (i) parameters RSSⱼ or parameters RSS^{j}_{b} are arranged in a descending order, (ii) sites, each of whose measured values RSS_{k,j} is any one from the largest one to the n-th largest one and satisfies a condition RSS_{k,j}≧RSS_{threshold}, are selected, and (iii) the sites thus selected constitute a set DUⱼ (j=1, 2, or Lu) of data transmission routes of a user device 10(Uⱼ).

With the method as above described, a set of data transmission routes of each user device 10(Uⱼ) in a cell is determined.

A set of signaling transmission routes of a user device 10(Uⱼ) is determined based an arrangement of the relay collaborative communication system 1. The arrangement of the relay collaborative communication system 1 encompasses a frame configuration of the relay stations Rj, etc. When the arrangement of the relay collaborative communication system 1 is determined, the set of signaling transmission routes corresponding to the user device 10(Uⱼ) is determined accordingly. According to the present embodiment, the set of signaling transmission routes of the user device 10(Uⱼ) is set to a set SUⱼ (j=1, 2, or Lu).

Each of the sites receives uplink signals from user devices 10 (U₁, U₂, and U₃) (see FIG. 1A), and feeds back measured reception qualities RSS (as indicated by the following [Formula 5]) of the uplink signals to the base station 30.

$$RSS = ( \begin{matrix}{RSS}_{1 , 1} & {RSS}_{1 , 2} & {RSS}_{2 , 3} \\ {RSS}_{2 , 1} & {RSS}_{2 , 2} & {RSS}_{2 , 3} \\ {RSS}_{3 , 1} & {RSS}_{2 , 2} & {RSS}_{2 , 3}\end{matrix} ) \qquad [ Formula 5 ]$$

Moreover, the following are sets of data transmission routes (see FIG. 2) determined by the route determining unit 206 of the base station 30 based on the above set criteria:

DU₁=(R₁)

DU₂=(R₂, R₃)

DU₃=(R₃)

Here, the uplink signals encompass all signals such as uplink reference signals and random-access signals.

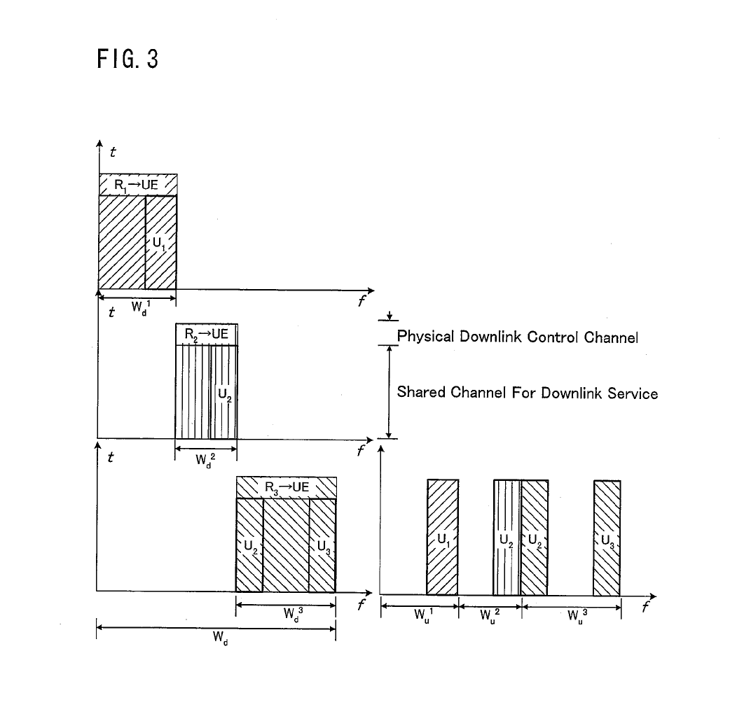

Each of FIGS. 3, 4, and 5 illustrates a signal transmitting method in a relay collaborative communication system 1 in which user devices 10(Uⱼ) are arranged in a different manner. According to a cellular communication system, transmissions are carried out by use of a time division multiplex via a physical downlink control channel (PDCCH) and a physical downlink shared channel (PDSCH).

According to the arrangement of the relay collaborative communication system 1 shown in FIG. 3, downlink operation bandwidths of the relay stations 20 (R₁, R₂, and R₃) are W¹_{d}, W²_{d}, and W³_{d}, respectively. The bandwidths W¹_{d}, W²_{d}, and W³_{d} do not overlap each other. Uplink operation bandwidths of the relay stations 20 (R₁, R₂, and R₃) are W¹ᵤ, W²ᵤ, and W³ᵤ, respectively. The following are sets of signaling transmission routes of the user devices 10(Uⱼ) determined by the route determining unit 206 in the relay collaborative communication system 1 having the arrangement shown in FIG. 3:

SU₁=(R₁)

SU₂=(R₂, R₃)

SU₃=(R₃)

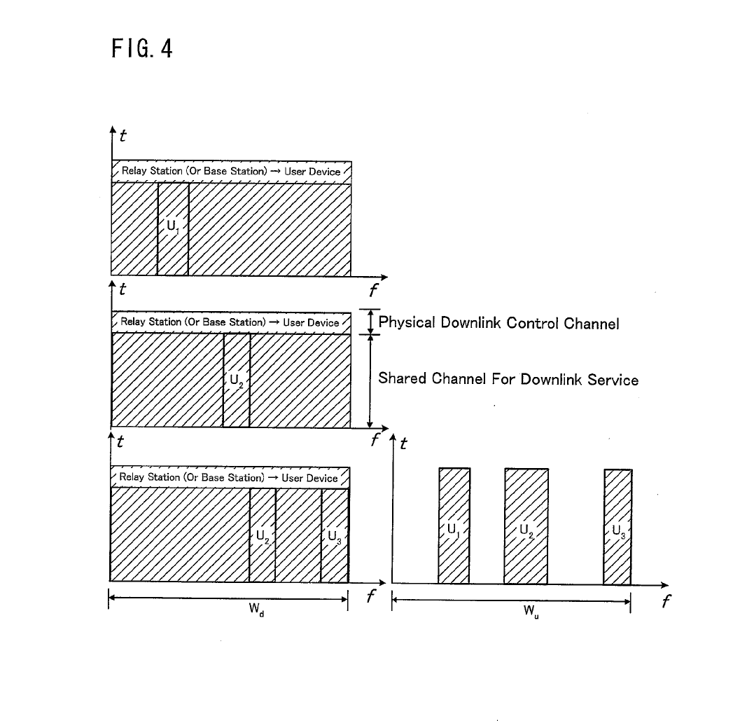

According to the arrangement of the relay collaborative communication system 1 shown in FIG. 4, each downlink operation bandwidth of the relay stations 20 (R₁, R₂, and R₃) is W_{d}. Each uplink operation bandwidth of the relay stations 20 (R₁, R₂ and R₃) is Wᵤ. The following are sets of signaling transmission routes of the user devices 10(Uⱼ) determined in the relay collaborative communication system 1 having the arrangement shown in FIG. 4:

SU₁=(R₁, R₂, R₃)

SU₂=(R₁, R₂, R₃)

SU₃=(R₁, R₂, R₃)

or

SU₁=(R₁, R₂, R₃, eNb)

SU₂=(R₁, R₂, R₃, eNb)

SU₃=(R₁, R₂, R₃, eNb)

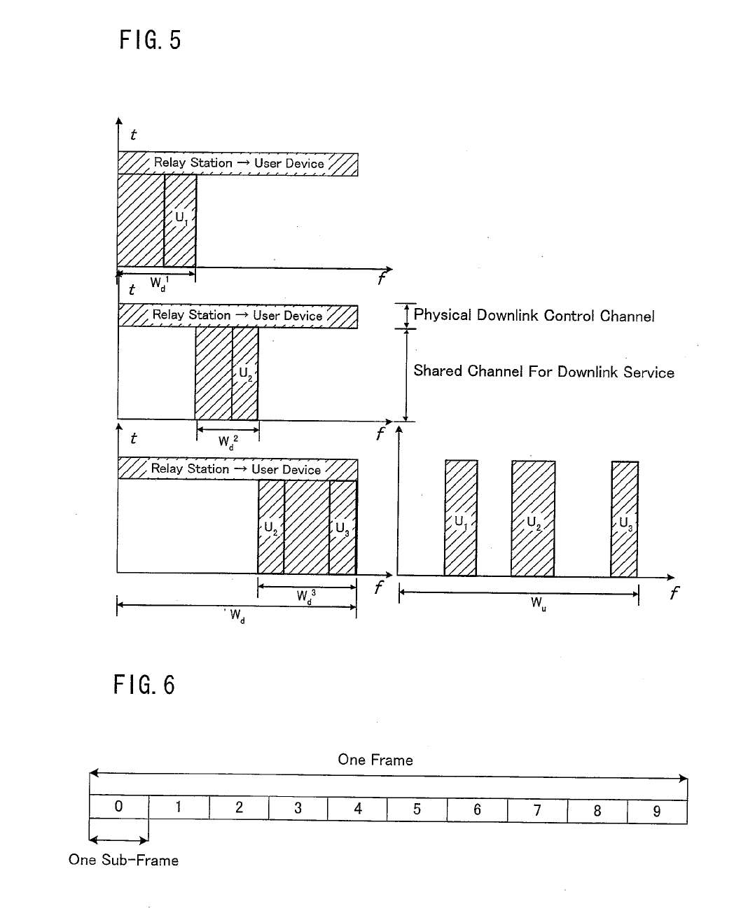

According to the arrangement of the relay collaborative communication system 1 shown in FIG. 5, each operation bandwidth of physical downlink control channels (PDCCH) of the relay stations 20 (R₁, R₂, and R₃) is W_{d}. An operation bandwidth of a downlink data sharing channel of the relay station 20 (R₁, R₂, or R₃) is identical to a downlink operation bandwidth of a user device 10(Uⱼ) which goes through a relay station 20 (R₁, R₂, or R₃). Each uplink operation bandwidth of the relay stations 20 (R₁, R₂, and R₃) is Wᵤ. The following are sets of signaling transmission routes of the user devices 10(Uⱼ) determined in the relay collaborative communication system 1 having the arrangement shown in FIG. 5:

SU₁=(R₁, R₂, R₃)

SU₂=(R₁, R₂, R₃)

SU₃=(R₁, R₂, R₃)

The following describes how to carry out an HARQ process, by exemplifying an FDD LTE system.

FIG. 6 illustrates a wireless frame configuration of the FDD LTE system. According to the FDD LTE system, sub-frames 0 and 5 contain respective downlink synchronization signals (synchronization signals), and sub-frames 4 and 9 contain respective paging signals of the system. The relay stations 20, therefore, do not receive downlink data from the base station 30, during the four sub-frames.

Downlink communication via a backhaul link is realized by carrying out a backhaul communication in a downlink direction between the base station 30 and the respective relay stations 20 during some sub-frames for each frame which are selected via a higher layer in the system. That is, the relay stations 20 receive data from the base station 30. It is possible to realize the backhaul communication in the downlink direction between the base station 30 and the respective relay stations 20 during selected some sub-frames with the use of the following first or second methods. According to the first method, when it is assumed that the backhaul communications are carried out during all the selected some sub-frames, the relay stations 20 do not transmit any data at all during the selected some sub-frames, and therefore relayed user devices 10 do not receive any data at all. Sub-frames of the first method are defined as “blank sub-frames”. According to the second method, each of the relay stations 20 carries out switching of, with the use of a time division system, transmission and reception during the selected some sub-frames. Specifically, each of the relay stations 20 downlink-transmits a control signal via a physical downlink control channel (PDCCH) during part of the selected some sub-frames, whereas each of the relay stations 20 receives data from the base station 30 during the other part of the selected some sub-frames. The sub-frames of the second method correspond to MBSFN (multimedia broadcast multicast service single frequency network) sub-frames in an LTE system. The following describes details of main technical idea of the present invention by exemplifying cases where the two types of sub-frames are used.

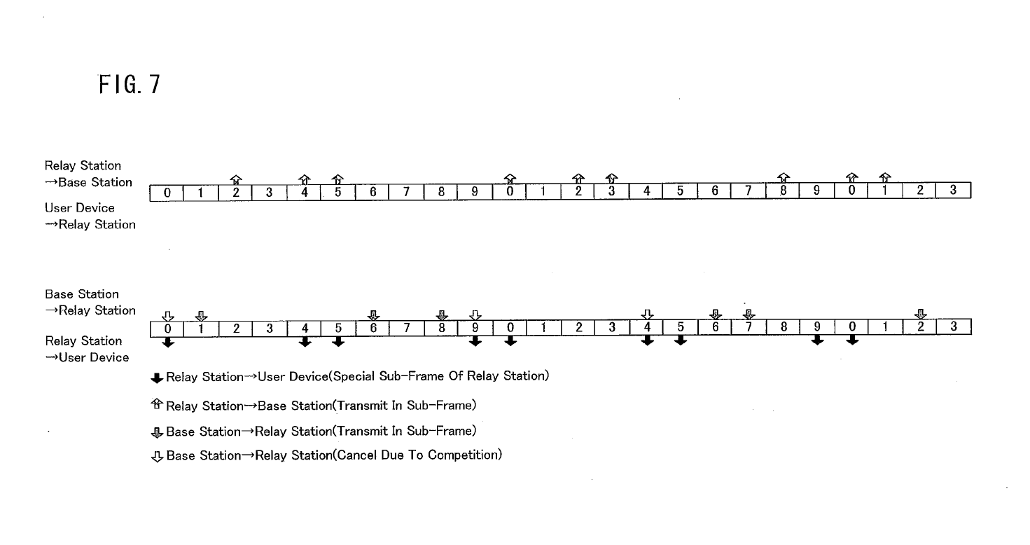

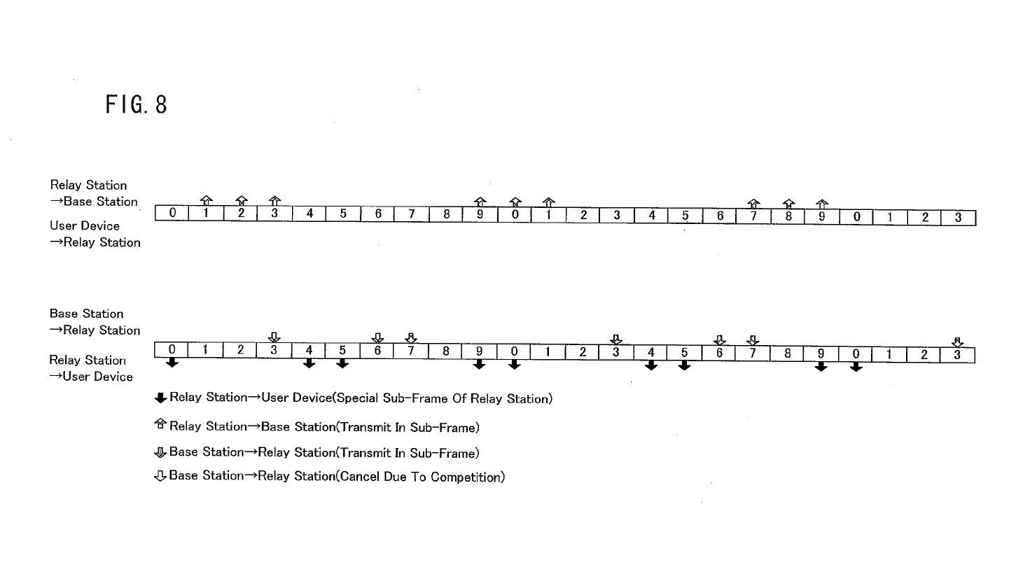

FIGS. 7 and 8 illustrate arrangements of the respective two types of sub-frames in a backhaul communication in the downlink direction. In each of FIGS. 7 and 8, “base station→relay station” indicates a downlink transmission from a base station 30 to a relay station 20 via the backhaul link, and “relay station→base station” indicates an uplink transmission from the relay station 20 to the base station 30 via the backhaul link. Moreover, “relay station→user device” indicates a downlink transmission from the relay station 20 to a user device 10 in an area where the communication services are offered. Each of sub-frames 0, 4, 5, and 9 (i) corresponds to a system sub-frame of the relay station 20 and (ii) has a broadcast channel (BCH) and a synchronization signal, etc. According to the arrangement, (i) a transmission from the base station 30 to the relay station 20 and (ii) a transmission of a special sub-frame by the relay station 20 are concurrently carried out. The “base station→relay station” indicates that backhaul downlink transmission (from the base station 30 to the relay stations 20) is cancelled at the time when the above transmissions (i) and (ii) are concurrently carried out. For example, the sub-frames 0, 9, and 4 temporally compete with system sub-frames of the relay station 20 (see FIG. 7). The relay station 20 therefore carries out only downlink transmissions during the sub-frames 0, 9, and 4 but does not receive a signal transmitted from the base station 30. This situation occurs only in a case where a backhaul link is arranged with the use of blank sub-frames. In a case where a backhaul link is arranged with the use of MBSFN sub-frames, no sub-frames temporally compete with system sub-frames.

The following describes examples of physical processes for realizing, via uplink or downlink, data transmission, retransmission, and feedback, etc. of a user device 10(Uⱼ) in a cellular system in which relay stations 20 collaboratively communicate based on (i) the two types of arrangements of backhaul downlink shown in FIGS. 7 and 8 and (ii) arrangements of a set of signaling transmission routes of and a set of data transmission routes of the user device 10(Uⱼ). The base station 30, the user devices 10, and the relay stations 20, etc. are configured as shown in FIGS. 1A through 1C.

### <Uplink HARQ—First Method—>

The base station 30 transmits uplink resources, which are allocated to a user device 10, to all sites in a set of signaling transmission routes via a backhaul link between the respective relay stations 20 and the base station 30. All the sites in the set of the signaling transmission routes downlink-transmit, to the user device 10, control instructions of wireless resource allocation at a certain scheduled time. After receiving the control instructions of wireless resource allocation, the user device 10 uplink-transmits signals with the use of scheduled wireless resources. Then, all sites in a set of data transmission routes receive the uplink signal from the user device 10, and feed back (i) ACKs to the user device 10 and (ii) demodulation results (ACK or NACK) to the base station 30. Then, the base station 30 receives the feedbacks such as an ACK or an NACK from all the sites in the set of data transmission routes of the user device 10. In a case where an ACK is contained in feedback regarding an uplink HARQ, it means that a current transmission is carried out successfully in the HARQ process. Whereas, in a case where the feedback regarding the uplink HARQ contain only an NACK, it means that the current transmission is carried out unsuccessfully in the HARQ process. In such a case, the base station 30 transmits a retransmission control signal for the user device 10 to all the sites in the set of the signaling transmission routes via the backhaul link. Then, all the sites in the set of signaling transmission routes receive the retransmission control signal and then downlink-transmit, to the user device 10, a retransmission instruction at a certain scheduled time. After receiving the retransmission instruction of the HARQ process, the user device 10 carries out a retransmission at the time in accordance with the retransmission instruction.

In a case where, in the uplink HARQ mechanism, (i) the user device 10 carries out a collaborative communication via the relay stations 20 or a base station 30 and (ii) all sites carry out feedbacks to the base station 30, the feedbacks are subjected to a lumped processing based on the following criteria.

TABLE 1
Scheduling by Base Station for
Retransmission in Uplink HARQ

| | | | Scheduling by |
|---|---|---|---|
| | Base station | Relay | base station for |
| | (or Relay station) | station | retransmission |
| 1 | ACK | ACK | Retransmission |
| | | | is not carried out |
| 2 | ACK | NACK | Retransmission |
| | | | is not carried out |
| 3 | NACK | ACK | Retransmission |
| | | | is not carried out |
| 4 | NACK | NACK | Retransmission |
| | | | is carried out |

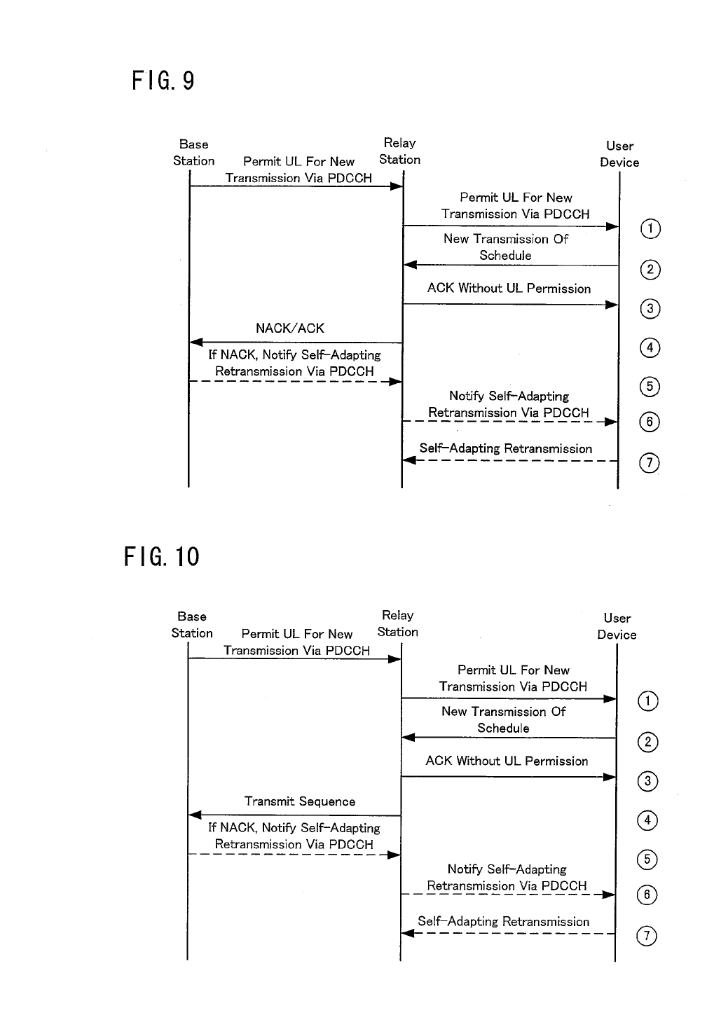

The following describes a concrete example with reference to FIG. 9.

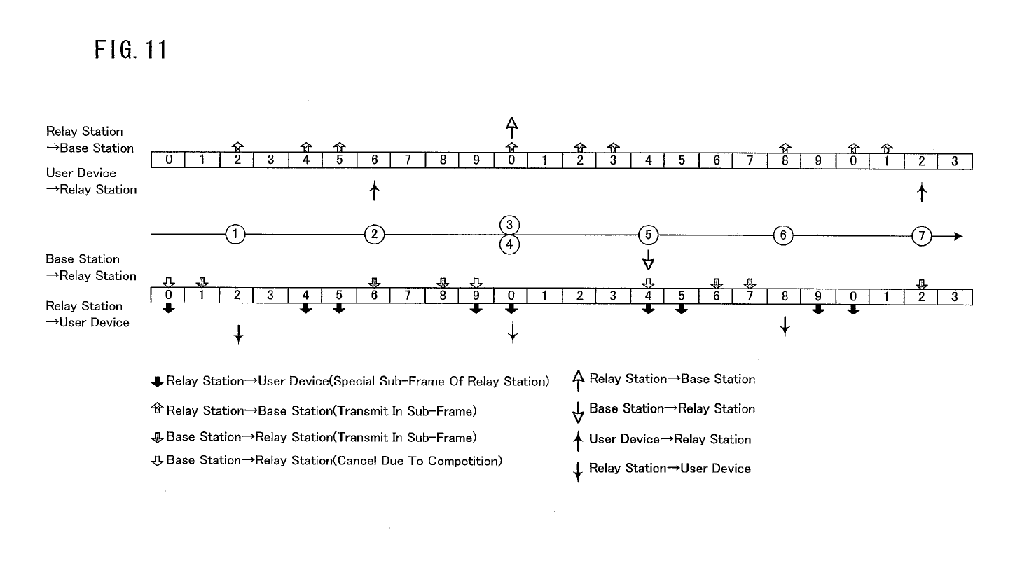

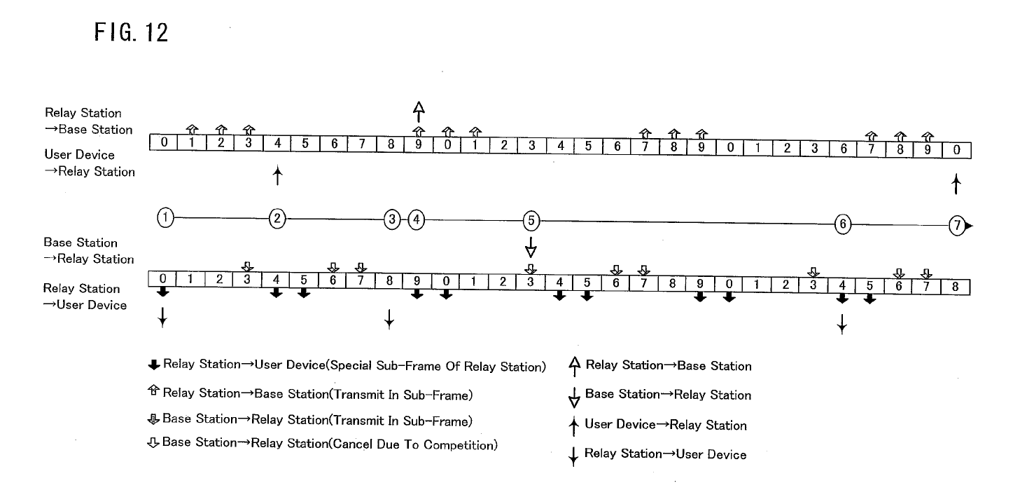

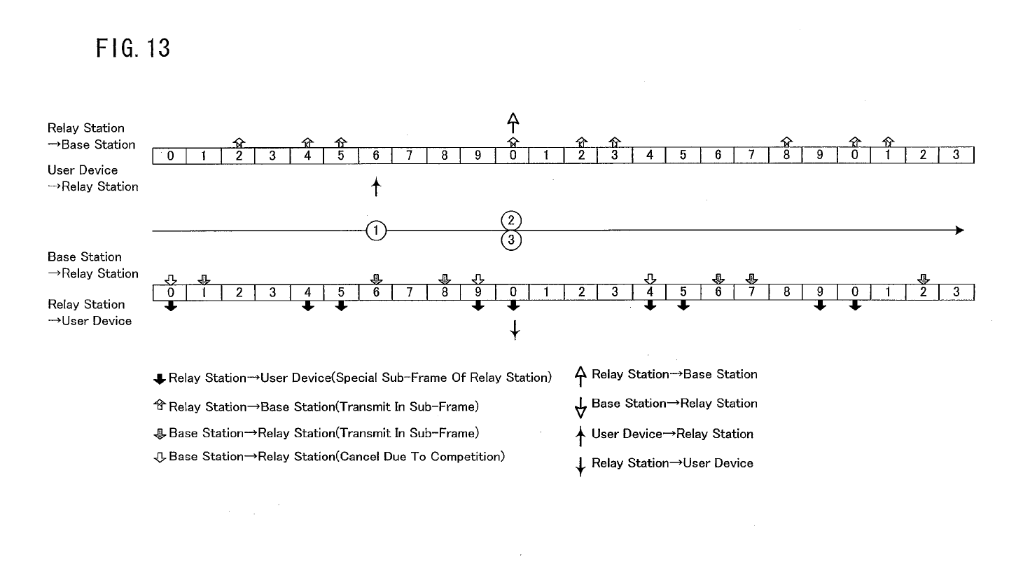

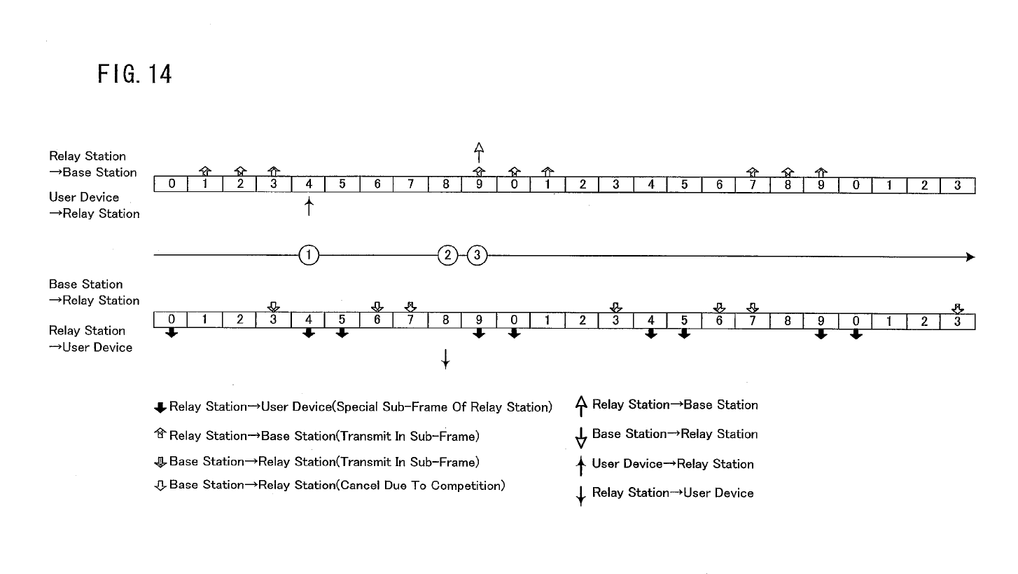

Note that FIG. 11 illustrates an example of a time sequence of a first transmission and a self-adapting retransmission in an uplink HARQ with the use of blank sub-frames. FIG. 12 illustrates an example of a time sequence of a first transmission and a self-adapting retransmission in an uplink HARQ with the use of MBSFN sub-frames. FIG. 13 illustrates an example of a time sequence of an ACK feedback in an uplink HARQ with the use of blank sub-frames. FIG. 14 is a schematic view illustrating a time sequence of an ACK feedback in an uplink HARQ with the use of MBSFN sub-frames.

Step 1: The base station 30 transmits an uplink scheduling instruction regarding a user device 10(Uⱼ) to all sites in a set SRⱼ of signaling transmission routes.

Step 2: All the sites in the set SRⱼ (i) schedule sub-frames via a physical downlink control channel (PDCCH) and (ii) downlink-transmit the uplink scheduling instruction to the relayed user device 10(Uⱼ). Here, the uplink scheduling instruction contains control information such as (i) allocation of an uplink wireless resource for the user device 10(Uⱼ) and (ii) a modulation method.

Step 3: The user device 10(Uⱼ) transmits an uplink signal with the use of the uplink resource allocated by the base station 30. All sites in a set DRⱼ of data transmission routes (i) receive the uplink signal, and (ii) carry out a detection with respect to the uplink signal thus received so as to decode the uplink signal.

Here, it is preferable to obtain a reception quality RSS^{j} (or RSS^{j}_{b}) of the uplink signal transmitted by the user device 10(Uⱼ) by measuring, with the use of all the relay stations 20(Rⱼ) (or all the relay stations 20(Rⱼ) and the base station 30) in the cell, all uplink reference signals and random-access signals, etc., which are transmitted by the user device 10(Uⱼ).

Step 4: Each of the sites in the set SRⱼ transmits a confirmation instruction of ACK (accurate reception) to the relayed user device 10(Uⱼ), regardless of whether or not the decoding processes are accurately carried out by the sites in the set DRⱼ with respect to the data received from the user device 10(Uⱼ).

Step 5: All the sites in the set DRⱼ feed back, to the base station 30, results of the decoding processes and CRCs (cyclic redundancy checks) which are obtained by carrying out the decoding processes and CRCs (cyclic redundancy checks) with respect to the data received from the user device 10(Uⱼ). For example, in a case where a result obtained by carrying out a CRC shows “accurate”, an ACK is fed back to the base station 30. Whereas, in a case where a result obtained by carrying out a CRC shows “inaccurate”, an NACK is fed back to the base station 30.

Here, it is preferable that all the relay stations 20(Rⱼ) (or all the relay stations 20(Rⱼ) and the base station 30) in the cell uplink-transmit, to the base station 30, the measured reception qualities RSS^{j} (or RSS^{j}_{b}) of an uplink signal transmitted by the user device 10(Uⱼ).

Step 6: The base station 30 determines, based on the feedback results supplied from all the sites in the set DRⱼ, whether or not the receptions of the current uplink signal, which is transmitted by the relayed user device 10(Uⱼ), are accurately carried out. In a case where feedbacks from all the sites in the set DRⱼ are NACKs, the base station 30 (i) determines that the receptions of the current uplink signal from the relayed user device 10(Uⱼ) are not accurately carried out and (ii) schedules a retransmission which is to be carried out by the relayed user device 10(Uⱼ). Whereas, in a case where a reception by at least one of the sites in the set DRⱼ is accurate and an ACK is fed back to the base station 30, Step 10 is carried out.

Here, it is preferable that the base station 30 (i) determines a new transmission route in a data channel of the user device 10(Uⱼ) based on the reception qualities RSS^{j} (or RSS^{j}_{b}), which are fed back to the base station 30 from the respective sites, of the uplink signal transmitted by the user device 10(Uⱼ) and (ii) renews the set DRⱼ of data transmission routes.

Step 7: The base station 30 downlink-transmits a retransmission instruction for the user device 10(Uⱼ) to all the sites in the set SRⱼ via a backhaul link between the respective relay stations 20(Rⱼ) and the base station 30.

Step 8: Each of all the sites in the set SRⱼ selects corresponding downlink transmission time and downlink-transmits the retransmission instruction to the relayed user device 10(Uⱼ). Here, in a case where a synchronization HARQ mechanism is used in the uplink, it is necessary to set the downlink transmission time to correspond to the same uplink HARQ process.

Step 9: The relayed user device 10(Uⱼ) carries out, in response to the retransmission instruction, retransmission with the use of a specified wireless resource, and then the process proceeds to Step 3.

Step 10: After the uplink transmission is carried out successfully, the base station 30 (i) selects one of the sites which has fed back the ACK and (ii) uploads data of the user device 10(Uⱼ) which has been accurately received.

### <Uplink HARQ—Second Method—>

The base station 30 transmits uplink resources, which are allocated to a user device 10(Uⱼ), to all sites in a set of signaling transmission routes via a backhaul link between the respective relay stations 20(Rⱼ) and the base station 30. All the sites in the set of the signaling transmission routes downlink-transmit, to the user device 10(Uⱼ), a control instruction of wireless resource allocation at a certain scheduled time. After receiving the control instruction of wireless resource allocation, the user device 10(Uⱼ) uplink-transmits a signal with the use of a scheduled wireless resource. Then, all sites in a set of data transmission routes receive the uplink signal from the user device 10(Uⱼ), and feed back (i) their ACKs to the user device 10(Uⱼ). The sites in the set of data transmission routes (i) obtain respective user device symbols, (ii) newly modulate the respective user device symbols, and (iii) transmits the respective user device symbols thus modulated to the base station 30 via respective backhaul links. Here, examples of the symbol sequence to be transmitted encompass (i) a sequence estimate obtained by detecting signals received by the sites, (ii) a symbol sequence generated by newly modulating symbols in a case where processes such as detection and decoding are carried out with respect to the symbols by the sites and the detection is successfully carried out, and (iii) a result of symbol detection carried out with respect to the signals received by the sites, which result is directly adopted when the detection is not successfully carried out. The base station 30 carries out detection and decoding processes with respect to received multiplex signals. In a case where the base station 30 successfully detects an ACK, the base station 30 (i) determines that a current transmission is successfully carried out in the HARQ process, (ii) selects a relay station 20(Rⱼ) which has fed back the ACK, and (iii) uploads data of the user device 10(Uⱼ) which has been accurately received. In a case where the base station 30 detects only NACK by a CRC, the base station 30 transmits a retransmission control signal for the user device 10(Uⱼ) to all the sites in the set of signaling transmission routes, via the backhaul links. Then, all the sites in the set of signaling transmission routes receive the retransmission control signal and then downlink-transmit, to the user device 10(Uⱼ), the retransmission instruction at certain scheduled time. After receiving the retransmission instruction of the HARQ process, the user device 10(Uⱼ) carries out a retransmission at the time corresponding to the retransmission instruction.

The following describes a concrete example with reference to FIG. 10.

Step 1: The base station 30 transmits an uplink scheduling instruction regarding a user device 10(Uⱼ) to all sites in a set SRⱼ of signaling transmission routes.

Step 2: All the sites in the set SRⱼ (i) schedule sub-frames via a physical downlink control channel (PDCCH) and (ii) downlink-transmit the uplink scheduling instruction regarding the relayed user device 10(Uⱼ). Note here that the uplink scheduling instruction contains control information such as (i) an allocation of uplink wireless resource for the user device 10(Uⱼ) and (ii) a modulation method.

Step 3: The user device 10(Uⱼ) transmits signals with the use of the uplink resources allocated by the base station 30. Each of sites in a set DRⱼ of data transmission routes (i) receives the uplink signal, (ii) carries out detection with respect to the uplink signal thus received, and (iii) decodes the uplink signal. In a case where a reception is determined to be successfully carried out based on a result of a CRC which is carried out with respect to the data, which is received from the user device 10(Uⱼ), by each site in the set DRⱼ, (i) a new symbolic sequence is generated, in accordance with a predetermined encoding and modulating methods, with the use of bit information obtained by decoding the signal from the user device 10(Uⱼ) and (ii) the new symbolic sequence thus generated is stored. In contrast, in a case where a reception is determined to be unsuccessfully carried out based on a result of a CRC, which is carried out by each site in the set DRⱼ with respect to the data received from the user device 10(Uj), a current result of symbol check, which is carried out with respect to the data received from the user device 10(Uⱼ), is stored.

Here, it is preferable that all the relay stations 20(Rⱼ) (or all the relay stations 20(Rᵢ) and the base station 30), in the cell, measure all signals such as an uplink reference signal and a random-access signal of the user device 10(Uⱼ) so as to obtain reception qualities RSS^{j} (or RSS^{j}_{b}) of uplink signals transmitted by the relayed user device 10(Uⱼ).

Step 4: Each of the sites in the set SRⱼ transmits a confirmation instruction of ACK (reception success) to the relayed user device 10(Uⱼ), regardless of whether or not the decoding process is accurately carried out, by the each of the sites in the set DRⱼ with respect to the data received from the user device 10(Uⱼ).

Step 5: Each of all the sites in the set DRⱼ newly modulates a symbolic sequence, which is stored in the each of all the sites, and which is related to the user device 10(Uⱼ) and then transmits the symbolic sequence thus modulated to the base station 30.

Here, it is preferable that all the relay stations 20(Rⱼ) (or all the relay stations 20(Rⱼ) and the base station 30) in the cell uplink-transmit, to the base station 30, the measured reception qualities RSS^{j} (or RSS^{j}_{b}) of an uplink signal transmitted by the user device 10(Uⱼ).

Step 6: The base station 30 carries out processes such as detection of symbol, decoding, and checking with respect to the symbol sequences of the user device 10(Uⱼ) which have been processed by and fed back by all the sites in the set DRⱼ. In a case where the checking is successfully carried out, the base station 30 determines that it successfully receives the current uplink transmission which is carried out by the relayed user device 10(Uⱼ), and then proceeds to Step 10. In a case where the checking is unsuccessfully carried out, the base station 30 (i) determines that the reception of the current uplink transmission from the relayed user device 10(Uⱼ) is unsuccessfully carried out and (ii) schedules a retransmission which is to be carried out by the relayed user device 10(Uⱼ).

Here, it is preferable that the base station 30 (i) determines a new transmission route of a data channel of the user device 10(Uⱼ) based on the reception quality RSS^{j} (or RSS^{j}_{b}), which is fed back to the base station 30 from each site, of the uplink signal transmitted by the user device 10(Uⱼ) and (ii) renews the set DRⱼ of data transmission routes.

Step 7: The base station 30 downlink-transmits a retransmission instruction for the user device 10(Uⱼ) to all the sites in the set SRⱼ via a backhaul link between the respective relay stations 20(Rⱼ) and the base station 30.

Step 8: Each of the sites in the set SRⱼ selects an appropriate downlink transmission time and downlink-transmit the retransmission instruction to the relayed user device 10(Uⱼ). Here, in a case where a synchronization HARQ mechanism is used in the uplink, it is necessary to make the downlink transmission time correspond to the same uplink HARQ process.

Step 9: The relayed user device 10(Uⱼ) carries out, in response to the retransmission instruction, a retransmission with the use of the allocated wireless resources, and then proceeds to Step 3.

Step 10: The uplink HARQ is ended when the uplink transmission is carried out successfully.

<Downlink HARQ>

The base station 30 transmits control signals of downlink service transmission to all sites in a set of signaling transmission routes via a backhaul link between the base station 30 and respective relay stations 20(Rᵢ). Moreover, the base station 30 transmits service data to all sites in a set of data transmission routes via the backhaul link between the base station 30 and the respective relay stations 20(Rⱼ). Then, at a certain scheduled time, all the sites in the set of signaling transmission routes downlink-transmit, to the user device 10(Uⱼ), (i) signals regarding the downlink service transmission and (ii) information data with the use of downlink resources allocated by the base station 30. Then, the user device 10(Uⱼ) carries out a CRC with respect to the received data, and then uplink-feeds back an ACK or NACK which is a check result. After receiving the uplink feedback from the user device 10(Uⱼ) regarding the current downlink transmission, all the sites in the set of data transmission routes uplink-transmit the feedbacks to the base station 30 via the backhaul link between the base station 30 and the respective relay stations 20(Rⱼ). Then, the base station 30 processes the multiple signals thus received. In a case where, for example, a detected feedback indicates an ACK, the base station 30 determines that the transmission in the process is successfully carried out. Whereas, in a case where a detected feedback indicates an NACK, the base station 30 (i) determines that the transmission in the process is unsuccessfully carried out and (ii) schedules a downlink retransmission.

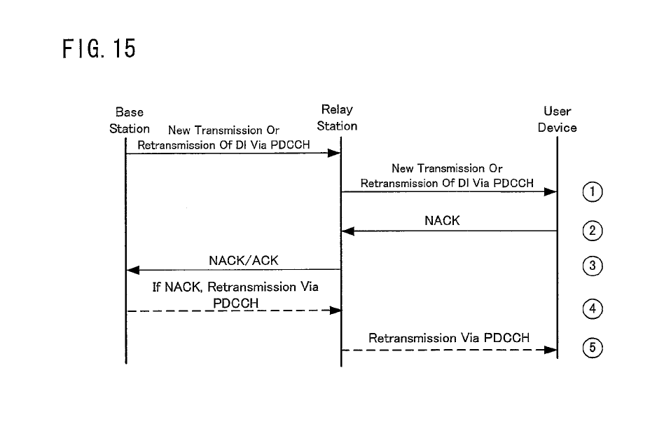

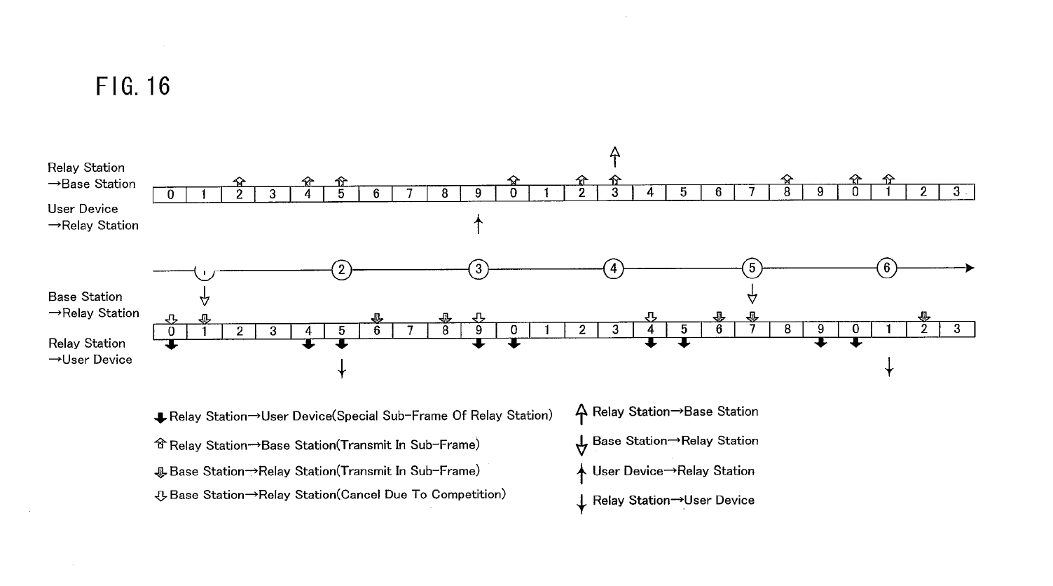

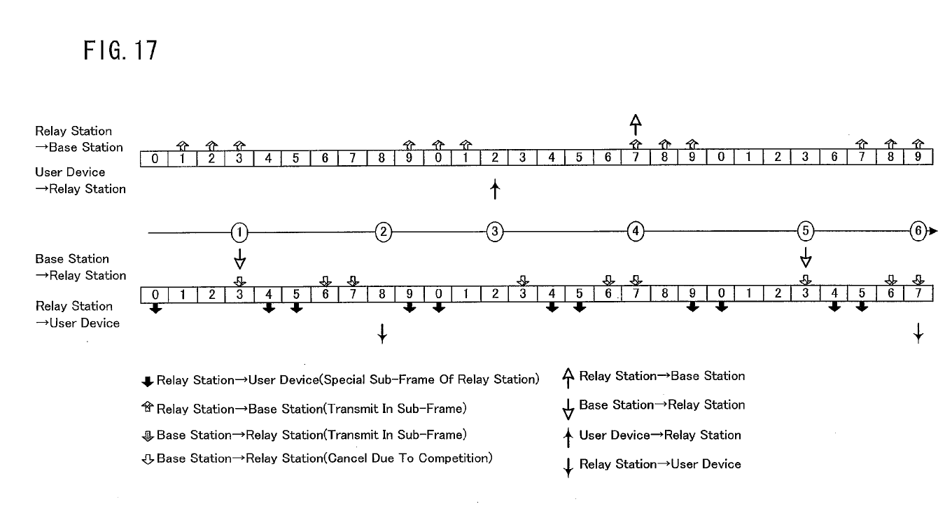

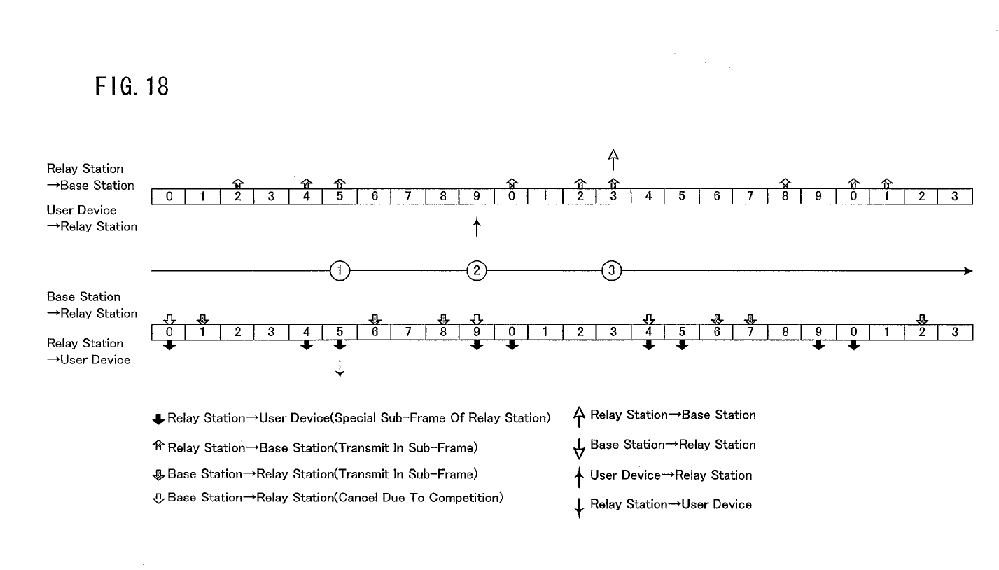

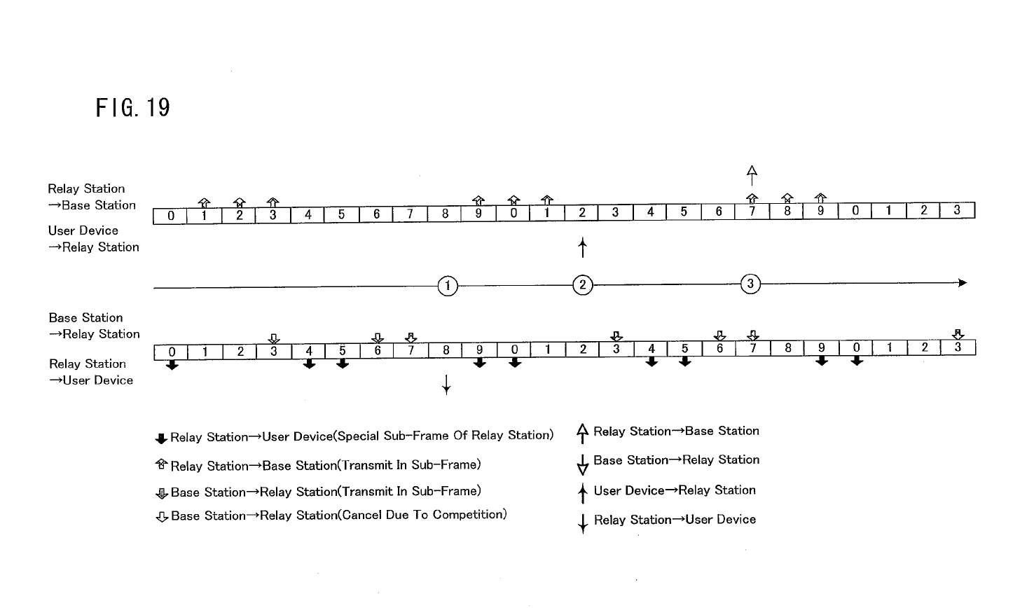

The following describes a concrete example with reference to FIG. 15. Note that FIG. 16 illustrates another example of a time sequence of an NACK feedback and a retransmission in a downlink HARQ in which blank sub-frames are used. FIG. 17 illustrates another example of a time sequence of an NACK feedback and a retransmission in a downlink HARQ with the use of MBSFN sub-frames. FIG. 18 illustrates another example of a time sequence of an ACK feedback and a retransmission in a downlink HARQ with the use of blank sub-frames. FIG. 19 illustrates another example of a time sequence of an ACK feedback and a retransmission in a downlink HARQ with the use of MBSFN sub-frames.

Step 1: The base station 30 (i) downlink-transmits, at scheduled time, a control signal containing information as to allocation of a wireless resource and a modulation method, etc. to all sites in a set SRⱼ of signaling transmission routes of the user device 10(Uⱼ) and (ii) downlink-transmits service data for the user device 10(Uⱼ) to all sites in a set DRⱼ of data transmission routes of the user device 10(Uⱼ).

Step 2: Each of the sites in the set SRⱼ receives the control signal containing information as to allocation of wireless resource and a modulation method, etc., and then downlink-transmits the control signal via a physical downlink control channel (PDCCH). Concurrently, each of the sites in the set DRⱼ downlink-transmits service data for the user device 10(Uⱼ) via a physical shared channel. Then, the user device 10(Uⱼ) receives the information data and the control signal which are downlink-transmitted from a plurality of sites.

Step 3: Based on the control signal thus received, the user device 10(Uⱼ) carries out processes, such as symbol detection, decoding, and CRC, with respect to the downlink service data thus received. For example, in a case where the CRC shows “accurate”, it means that the downlink transmission is accurately received. Whereas, in a case where the CRC shows “error”, it means that the downlink transmission is inaccurately received.

Step 4: An ACK or an NACK is subjected to uplink feedback by the user device 10(Uⱼ), and all the relay stations 20(Rᵢ) or all the relay stations 20(Rⱼ) and the base station 30, in the cell, receive the uplink feedback from the user device 10(Uⱼ)

Here, it is preferable that all the relay stations 20(Rⱼ) (or all the relay stations 20(Rⱼ) and the base station 30) in the cell measure signals, such as all uplink reference signals and random-access signals, of the user device 10(Uⱼ) so as to obtain a reception quality RSS^{j} (or RSS^{j}_{b}) of an uplink signal transmitted by the user device 10(Uⱼ).

Step 5: All the sites in the set DRⱼ newly modulates the uplink feedback from the user device 10(Uⱼ), and then transmit the feedback thus modulated to the base station 30.

Here, it is preferable that all the relay stations 20(Rⱼ) (or all the relay stations 20(Rⱼ) and the base station 30) in the cell uplink-transmit, to the base station 30, the reception quality RSS^{j} (or RSS^{j}_{b}), which has been measured and obtained, of the uplink signal transmitted by the user device 10(Uⱼ).

Step 6: In a case where the feedback received from each of the sites indicates failure of reception by the user device 10(Uⱼ), the base station 30 schedules a downlink retransmission and generates a corresponding control signal, and then proceeds to Step 1. Otherwise, the base station 30 proceeds to Step 7.

Here, it is preferable that the base station 30 (i) determines a new transmission route of a data channel of the user device 10(Uⱼ) based on the reception quality RSS^{j} (or RSS^{j}_{b}), which is fed back to the base station 30 from each of the sites, of the uplink signal transmitted by the user device 10(Uⱼ) and (ii) renews the set DRⱼ of the data transmission routes.

Step 7: The downlink HARQ is ended when the current downlink transmission is carried out successfully.

According to the uplink and downlink HARQ mechanisms of the present invention, how to determine (i) a set of signaling transmission routes of the user device 10(Uⱼ) and (ii) a set of data transmission routes of the user device 10(Uⱼ) is of course not limited to the embodiment above described.

The details of the present invention are described above based on the concrete embodiment. However, it is clear that the present invention may be altered in various ways within the scope of the present invention. Therefore, the scope of the present invention is not limited to the description of the embodiments above, but should be interpreted within the scope of the claims and equivalents of the claims.

### INDUSTRIAL APPLICABILITY

The present invention can be applied to a cellular system in which a relay station collaboratively carries out a communication.

1. A communication method of a relay collaborative cellular communication system including a base station and at least one relay station, said communication method comprising the steps of:
(a) causing the at least one relay station or the at least one relay station and the base station to measure a reception quality of an uplink signal transmitted from each user device;
(b) causing the at least one relay station to feed back a measured reception quality to the base station; and
(c) causing the base station to determine a transmission route between the each user device and the base station based on the reception quality.

2. The communication method as set forth in claim 1, wherein:
in the step (a), the reception quality is a result obtained by carrying out, with respect to an uplink reference signal or a random-access signal transmitted from the each user device, a measurement of at least one of a signal-to-noise ratio, a carrier-to-interference ratio, and a received power.

3. The communication method as set forth in claim 1, wherein:
in the step (c), the base station judges, for determining the transmission route, whether or not a reception quality of the each user device is higher than a predetermined threshold level.

4. The communication method as set forth in claim 1, wherein:
in the step (c), the base station (i) selects, for the each user device, the number of the at least one relay station which number causes the reception quality to be maximized and (ii) causes the at least one relay station thus selected to serve as a route site(s) for the each user device.

5. A communication method of a relay collaborative cellular communication system including a base station and at least one relay station, said communication method comprising the steps of:
(a) causing the base station to determine a route site for a user device based on a reception quality measured by (i) the base station and the at least one relay station or (ii) the at least one relay station;
(b) causing the user device to transmit a signal with use of an uplink resource which is allocated to the user device;
(c) causing the user device to carry out, based on lumped scheduling of the base station, a downlink reception, an uplink transmission, an uplink retransmission, or a downlink retransmission, and causing the route site to process schedule control information and to transmit the schedule control information to the user device; and
(d) in an uplink hybrid automatic repeat request (HARQ) mechanism, causing the at least one relay station or the at least one relay station and the base station to feed back a confirmation of accurate reception to the user device, regardless of whether or not the at least one relay station or the at least one relay station and the base station successfully receive(s) an uplink signal transmitted from the user device.

6. The communication method as set forth in claim 5, wherein:
the reception quality is a result obtained by carrying out, with respect to an uplink reference signal or a random-access signal transmitted from the user device, a measurement of at least one of a signal-to-noise ratio, a carrier-to-interference ratio, and a received power.

7. The communication method as set forth in claim 5, wherein:
in the step (a), in order to determine a transmission route between the each user device and the base station, the base station judges, for the each user device, whether or not a reception quality is higher than a predetermined threshold level.

8. The communication method as set forth in claim 5, wherein:
in the step (a), the base station (i) selects, for the each user device, the number of the at least one relay station which number causes the reception quality to be maximized and (ii) causes the at least one relay station thus selected to serve as a route site(s) for the each user device.

9. The communication method as set forth in claim 5, wherein:
in the uplink HARQ mechanism, the at least one relay station feeds back, to the base station, a result obtained by carrying out decode checking with respect to an uplink signal transmitted from the user device.

10. The communication method as set forth in claim 5, wherein:
in the uplink HARQ mechanism, the at least one relay station (i) processes an uplink signal, received from the user device, so as to generate a new symbolic sequence, (ii) re-modulates the new symbolic sequence, and then (iii) transmits the new symbolic sequence to the base station.

11. The communication method as set forth in claim 5, wherein:
in the uplink HARQ mechanism,
in a case where all received feedbacks indicate failure of reception, the base station schedules an uplink retransmission which is to be carried out by the user device; or
in other cases, the base station determines that reception of an uplink signal transmitted from the user device is successfully carried out.

12. The communication method as set forth in claim 5, wherein:
in the uplink HARQ mechanism, the at least one relay station carries out a decode checking with respect to an uplink signal transmitted from the user device,
in a case where an accurate reception is confirmed by the decode checking, the at least one relay station modulating decoded bits by newly encoding the decoded bits so as to newly generate a symbolic sequence, which is to be transmitted to the base station, or
in a case where a result obtained by carrying out the decode checking indicates failure of reception, the at least one relay station carrying out detection of symbols with respect to the uplink signal, and a symbolic sequence thus obtained being to be transmitted to the base station.

13. The communication method as set forth in claim 5, wherein:
in the uplink HARQ mechanism, the base station (i) receives a new symbolic sequence which is generated, by a plurality of sites, from an uplink signal of the user device and (ii) carries out decode checking with respect to the new symbolic sequence,
in a case where success of reception is confirmed by the decode checking, the base station accurately receiving the uplink signal transmitted from the user device, or
in a case where failure of reception is confirmed by the decode checking, the base station scheduling a retransmission which is to be carried out by the user device.

14. The communication method as set forth in claim 5, wherein:
in the uplink HARQ mechanism, the base station selects a relay station, which feeds back an acknowledgment (ACK), so as to carryout a scheduling,
a selected relay station transmitting, to the base station, an uplink signal which has been accurately received from the user device.

15. A relay collaborative cellular communication system including a base station and at least one of relay station,
the at least one relay station including:
a first receiving device which receives a first signal from a user device,
a first measuring device which measures a first reception quality of the first signal, and
a transmitting device which feeds back the first reception quality from the at least one relay station to the base station; and
the base station including:
a second receiving device which receives a second signal from the user device,
a second measuring device which measures a second reception quality of the second signal, and
a route determining device which determines a transmission route between the user device and the base station based on the first reception quality and the second reception quality.

16. The relay collaborative cellular communication system as set forth in claim 15, wherein:
each of the first measuring device and the second measuring device obtains the first or second reception quality by carrying out, with respect to an uplink reference signal or a random-access signal transmitted from the user device, a measurement of at least one of a signal-to-noise ratio, a carrier-to-interference ratio, and a received power.

17. The relay collaborative cellular communication system as set forth in claim 15, wherein:
in order to determine the transmission route, the route determining device judges, for the each user device, whether or not each of the first reception quality and the second reception quality is higher than a predetermined threshold level.

18. The relay collaborative cellular communication system as set forth in claim 15, wherein:
the route determining device (i) selects, for the each user device, the number of the at least one relay station which number causes the first reception quality and the second reception quality to be maximized and (ii) causes the at least one relay station thus selected to serve as a route site(s) for the each user device.
